(19) United States
(12) Patent Application Publication
(10) Pub. No.: US 2004/0015958 A1
(43) Pub. Date: Jan. 22, 2004

(54) Method and system for conditional installation and execution of services in a secure computing environment

(76) Inventors: Leonard Scott Veil, Campbell, CA (US); Erica Elisabeth Tups, Santa Clara, CA (US)

Correspondence Address: BAKER & BOTTS, 30 ROCKEFELLER PLAZA, NEW YORK, NY, 10112

(21) Appl. No.: 09/855,898

(22) Filed: May 15, 2001

(51) Int. Cl. G06F 9/44; G06F 9/445; H04L 9/00; G06F 11/30; G06F 12/14

(52) U.S. Cl. 717/174; 717/171; 713/164; 713/191

(57) ABSTRACT

A system and method are provided for installing and executing an applet in a secure processor. The system and method can receive the applet in non-secure data storage. The applet includes a meta-data portion and an executable portion. The meta-data portion includes a security meta-data portion, a resource meta-data portion, and a meta-data signature portion. The system and method determines whether the applet is capable of being executed by the secure processor based at least in part on the security meta-data portion and the resource meta-data portion of the applet, and if the applet can be executed by the secure processor, the applet is installed on the secure processor.

### FIELD OF THE INVENTION

The present invention relates to cryptographic systems. In particular, the present invention relates to a secure installation and execution of authenticated software applications.

### BACKGROUND OF THE INVENTION

Many computer applications need to perform one or more secure functions. A secure function is a computer program, a feature of that computer program, or an operation of that computer program that is highly resistant to tampering by the user or a third party.

For example, a software program may have an expiration date after which the software applet program becomes inoperable. However, a typical software expiration function is not secure because it is easily defeated by resetting the local computer clock to an earlier time setting, or by modifying the software to jump over the portion of the program that checks the local computer clock.

As another example, a computer program that keeps a record of data accessed from a local encrypted database for the purpose of charging for the use of the local encrypted database typically has two critical registers. A first register represents the amount of past data usage, and another register represents the amount of remaining credit. However, if updating the usage and credit registers is not a secure function, the user could reduce the contents of the usage register and/or increase the contents of the credit register to defeat the system. Similarly, rented software that keeps a record of its own usage for rental charge purposes needs a secure function to prevent the user from tampering with the rental accounting registers, and other critical internal registers and functions.

As another example, a remote access database may charge authorized users for access to the database. A secure function is often needed to authenticate the identity of each user before granting access to the database. Yet another secure function is key management, i.e., the distribution of cryptographic keys to authorized users.

One class of secure function solutions is to implement secure functions in client desktop software. Implementing a secure function in desktop software has the advantage of being virtually universal. However, implementing a secure function in desktop software is not as secure as implementing a secure function in hardware. On the other hand, a hardware implementation of a secure function is more costly than software, and may require specialized hardware for each application. If each application requires its own specialized hardware, a hardware implementation of a secure function is not universal.

### SUMMARY OF THE INVENTION

An object of the present invention is to provide a system and method for the conditional installation and execution of an applet in a secure environment. In a particular embodiment, the present invention provides for the installation of an applet only if a secure processor has the resources to execute the applet.

In accordance with a first exemplary embodiment of the method of the present invention, there is provided a method for securely installing an applet on a computer system having a data storage and a secure processor. An aspect of the invention includes receiving the applet in the data storage, determining from at least a portion of the applet whether the applet is capable of being executed by the secure processor, and installing the applet on the secure processor if the secure processor is capable of executing the applet. In one aspect of the invention, the applet includes a meta-data portion, an executable portion, and a certificate portion. In another aspect of the invention, the meta-data portion includes a security meta-data portion, a resource meta-data portion which designates any resources required by the applet for execution, and a meta-data signature portion.

According to a second exemplary embodiment of the method of the present invention, there is provided a method for securely installing an applet on a computer system having a non-secure data storage and a secure processor. Another aspect of the invention includes receiving the applet in the non-secure data storage. The applet includes a meta-data portion and an executable portion, where the meta-data portion includes a security meta-data portion, a resource meta-data portion, and a meta-data signature portion. Yet another aspect of the invention includes determining whether the applet is capable of being executed by the secure processor based at least in part on the security meta-data portion and the resource meta-data portion of the applet. In an aspect of the invention, this includes verifying that a secure processor security requirement of the security meta-data portion of the applet is met or exceeded by a secure processor security rating of the secure processor, and installing the applet on the secure processor if the secure processor is capable of executing the applet.

According to a third exemplary embodiment of the method of the present invention, there is provided a list of alternative applets for a first applet which could not be installed in a computer having at least one resource and having a secure processor which is associated with a security rating. Another aspect of the invention includes receiving a request from the secure processor for the list of alternative applets, which includes an applet serial number that identifies the first applet, a unit identifier that identifies the secure processor, a first indicator that identifies the security rating of the secure processor, and a second indicator that identifies the at least one resource of the computer. In an aspect of the invention, the list of alternative applets is created from the plurality of applets based at least in part on the first indicator and the second indicator, and the list of alternative applets is transmitted to the computer. In another aspect of the invention, the method further includes installing an alternative applet from the list of alternative applets, and charging a premium for installing the alternative applet.

According to a fourth exemplary embodiment of the method of the present invention, a secure applet execution system is provided including a data storage element storing an applet received by the secure applet execution system, and a secure processor determining from at least a portion of the applet whether the applet is capable of being executed by the secure processor, and the applet is installed on the secure processor if the secure processor is capable of executing the applet. In yet another aspect of the invention, the applet further includes a meta-data portion, and an executable portion.

According to a fifth exemplary embodiment of the method of the present invention, a secure applet execution system is provided that includes a non-secure data storage element storing an applet received by the secure applet execution system. In an aspect of the invention, the applet includes a meta-data portion, and an executable portion, the meta-data portion including a security meta-data portion, a resource meta-data portion, and a meta-data signature portion. A secure processor determines from at least a portion of the applet whether the applet is capable of being executed by the secure processor, and the applet is installed on the secure processor if the secure processor is capable of executing the applet.

### BRIEF DESCRIPTION OF THE DRAWINGS

Further objects, features, and advantages of the invention will become apparent from the following detailed description taken in conjunction with the accompanying figures showing illustrative embodiments of the invention, in which:

FIG. 1 is a block diagram illustrating a system for downloading applets from an applet server;

FIG. 2 is a block diagram illustrating the structure of an applet;

FIG. 3 is a flow chart illustrating the applet installation and execution process;

FIG. 4 is a flow chart illustrating the first applet verification in more detail;

FIG. 5 is a flow chart illustrating the verification of an executable portion of the applet in more detail;

FIG. 6 is a flow chart illustrating the execution of the executable portion of the applet in more detail;

FIG. 7 is a flow chart illustrating a response of an applet server to a request for an applet;

FIG. 8 is a flow chart illustrating a response of the applet server to a request for a decryption key; and

FIG. 9 is a flow chart illustrating a response of the applet server to a request for alternative applets.

Throughout the figures, unless otherwise stated, the same reference numerals and characters are used to denote like features, elements, components, or portions of the illustrated embodiments. Moreover, while the subject invention will now be described in detail with reference to the figures, and in connection with the illustrative embodiments, changes and modifications can be made to the described embodiments without departing from the true scope and spirit of the subject invention as defined by the appended claims.

### DETAILED DESCRIPTION OF THE INVENTION

U.S. patent Ser. No. 09/313,295, filed Mar. 17, 1999, to Steven J. Sprague and Gregory J. Kazmierczak entitled “Public Cryptographic Control Unit and System Therefor” (hereinafter “Sprague et al.”), the entire specification of which is herein incorporated by reference, describes a cryptographic control unit in which applets can be swapped in and/or out.

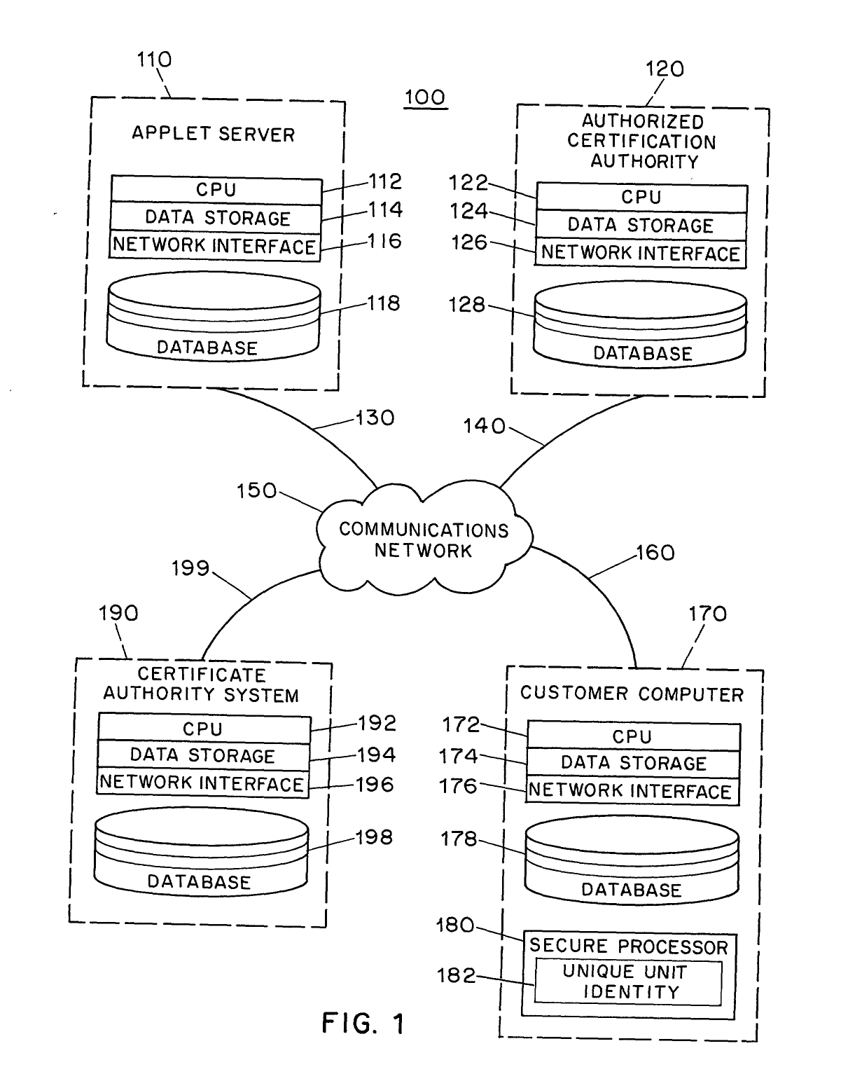

FIG. 1 illustrates a system 100 for downloading applets from an applet server 110, for example, as disclosed as a software developer PC in Sprague et al., installing the applets on a customer computer 170, for example, as disclosed as a desktop PC in Sprague et al., and executing the applets on a secure processor 180, for example, as disclosed as the public cryptographic control unit in Sprague et al., in a secure fashion. The applet server 110 including a CPU 112, a data storage element 114, a network interface 116, and a database 118 is provided. The data storage element 114 contains information describing various customers and applets. A network connection 130 connects the applet server 110 to a communications network 150 via the network interface 116 allowing the web server 110 to communicate over the communications network 150. Preferably, the communications network 150 is the Internet, but can be direct modem lines, wireless connections or the like.

An authorized certification authority 120, for example, as disclosed as a cryptographic operations center in Sprague et al., including a CPU 122, a data storage unit 124, a network interface 126, and a database 128 is provided. A network connection 140 connects the authorized certification authority 120 to the communications network 150 via the network interface 126 allowing the authorized certification authority 120 to communicate over the communications network 150.

A customer computer 170 including a CPU 172, a data storage unit 174, a network interface 176, a database 178, and the secure processor 180 having a unique identity 182, as described as the unique unit identity in Sprague et al., is provided. A network connection 160 connects the customer computer 170 to the communications network 150 via the network interface 176 allowing the customer computer 170 to communicate over the communications network 150.

A certificate authority system 190 including a CPU 192, a data storage unit 194, a network interface 196, and a database 198 is provided. A network connection 199 connects the certificate authority system 190 to the communications network 150 via the network interface 196 allowing the certificate authority system 190 to communicate over the communications network 150. The certificate authority system 190 provides a trusted certificate hierarchy wherein the certificates and associated public keys of the applet server 110 and the authorized certification authority 120 are known to the secure processor 180 within the customer computer 170.

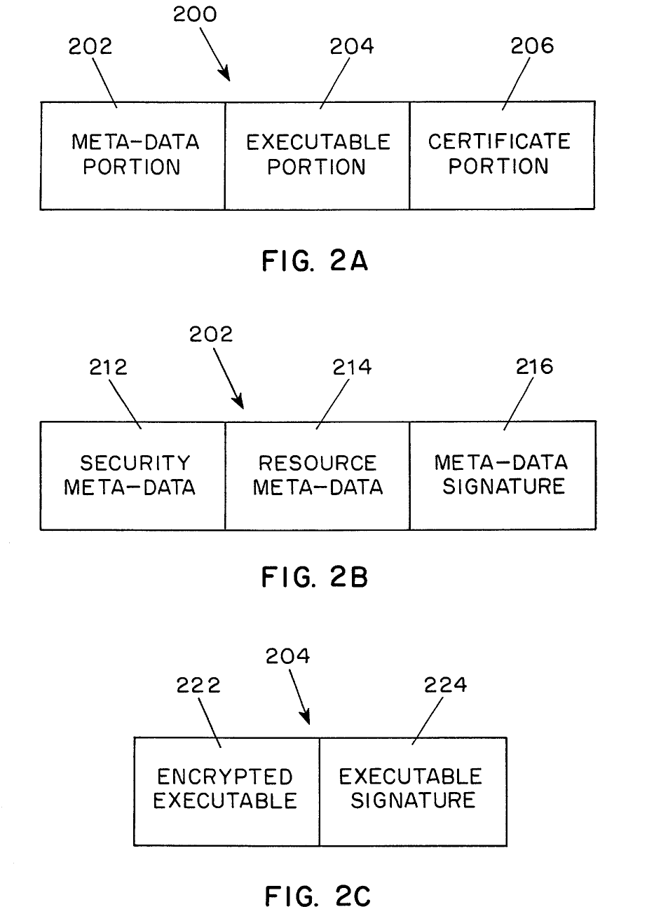

FIG. 2A shows an applet 200, which includes a meta-data portion 202, an executable portion 204 and a certificate portion 206. The meta-data portion 202, shown in FIG. 2B, includes a security meta-data portion 212, a resource meta-data portion 214, and a meta-data signature portion 216. The resource meta-data portion 214 includes information specifying required resources and an applet serial number, as disclosed as an applet serial number in Sprague et al. The required resources may include, for example, a biometric sensor, a secure output, a keyboard, a personal identification number entry device, a first smart card slot, a second smart card slot, a finger print scanner, a general purpose scanner, a disk drive, a global positioning system input, a magnetic stripe card reader, a secure storage area, a performance metrics, which define minimum standards for hardware, an algorithm implementing specific cryptographic algorithms, and the like. The applet serial number indicates the applet to which the meta-data portion 202 belongs. The meta-data signature portion 216 is created by the authorized certification authority 120. The executable portion 204, shown in FIG. 2C, includes an encrypted executable portion 222 and an executable signature portion 224. The executable signature portion 224 is created by the authorized certification authority 120. The certificate portion 206 is created by the certificate authority system 190. Once the software applet is downloaded, it is stored in the data storage unit 174.

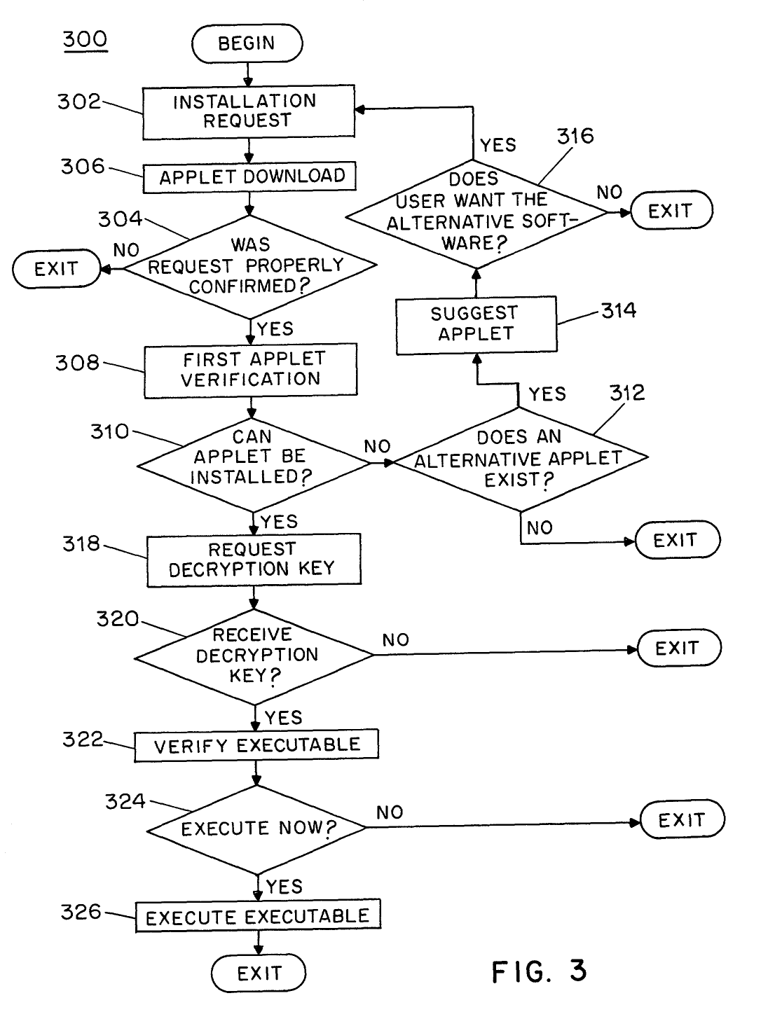

FIG. 3 illustrates the software applet installation and execution process 300. To initiate the software applet installation and execution process 300, the customer computer 170 requests the applet 200 from the applet server 110 at step 302. The request includes the unique unit identifier 182 and an applet serial number. This causes the customer computer 170 to send an applet request over the communications network 150 to the applet server 110. In an alternative embodiment, the customer computer 170 reads the applet 200 from a distribution media, as described as the distribution media in Sprague et al., or from some other source. At step 306, the customer computer 170 downloads the applet 200 to the data storage unit 174 of the customer computer 170.

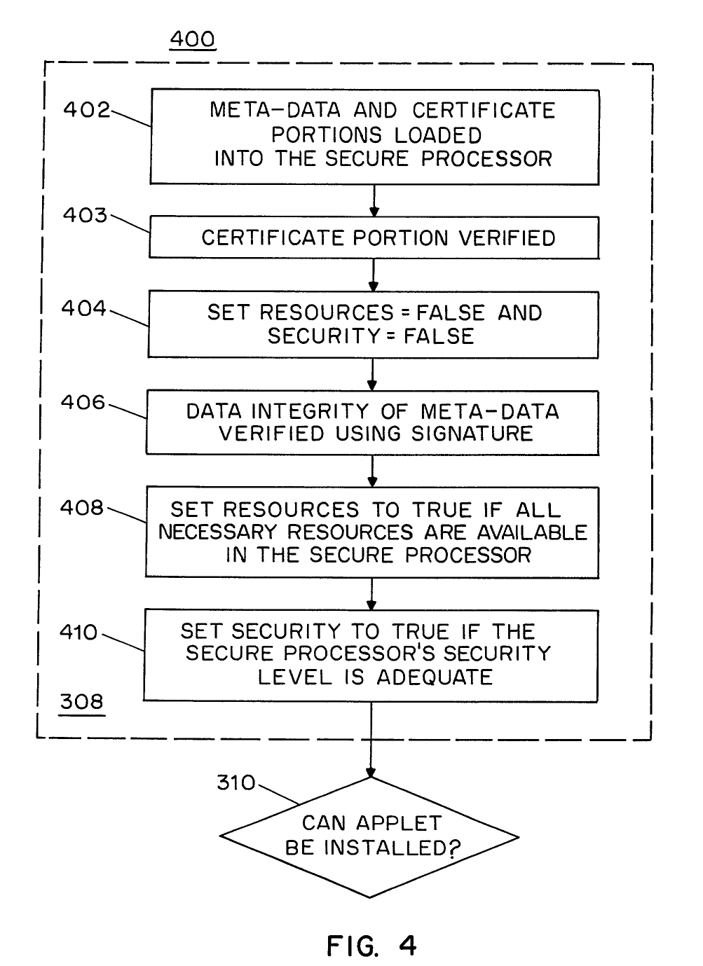

The applet installation request is verified at step 304. The customer computer 170 prompts the customer to provide an authentication code to verify that the request originated from the customer. If the authentication code provided by the customer matches the authentication code stored within the secure processor 180 for the unique identity 182, an applet 200 is a candidate for installation. If the authentication code does not match the authentication code stored on the within the secure processor 180 for the unique identity 182, the process 300 is halted, the installation process receives an error message, and the process 300 exits. At step 308 the secure processor 180 verifies the ability of the secure processor 180 to execute the applet 200 at step 308, further detailed in FIG. 4. Alternatively, initially only the meta-data portion 202 and the certificate portion 206 are downloaded to the customer computer 170 for the verification in step 308. Further this initial download of the meta-data portion 202 and the certificate portion 206 can be downloaded directly to data storage in the secure processor 182.

In FIG. 4, the meta-data portion 202 and the certificate portion 206 of the applet 200 are moved into the secure processor 180 from the data storage unit 174 at step 402. After the meta-data portion 202 is moved into the secure processor 180, the certificate portion 206 of the applet 200 is verified by the secure processor 180 using the Rivest, Shamir and Adleman algorithm at step 403. If the secure processor 180 verifies that the certificate authority system 190 created the certificate portion 206, the process 300 advances to step 404. If the certificate authority system 190 did not create the certificate portion 206, the process 300 exits.

A temporary variable resource is set to FALSE and a temporary variable security is set to FALSE at step 404. This is done to indicate that the secure processor 180 is not known to have the requisite security level to execute the applet nor is the secure processor 180 known to have the necessary resources to execute the applet.

The data integrity of the meta-data portion 202 of the applet 200 is verified at step 406. The secure processor 180 verifies the data integrity of the security meta-data portion 212 and the resource meta-data portion 214 against the meta-data signature portion 216 using a public key verification algorithm. In a certain embodiment, the Rivest, Shamir and Adleman algorithm is used. Initially, before the applet 200 is downloaded from the applet server 110, the meta-data signature portion 216 was created based on the security meta-data portion 212 and the resource meta-data portion 214. If any information in the security meta-data portion 212 or the resource meta-data portion 214 is altered between the time the meta-data signature portion 216 was created and the time when the verification takes place, the verification process fails. If the verification process fails, the process 300 exits and indicates an error. If the verification process detects no modifications in the security meta-data portion 212 and the resource meta-data portion 214, the process 300 continues.

The availability of the necessary resources on the secure processor 180 is verified at step 408. The resource meta-data portion 214 specifies a number of resources the executable may need when executed. Preferably, the resource meta-data portion 214 specifies every resource the executable may need when executed. All the resources specified in the resource meta-data portion 214 must be available on the secure processor 180 in order to install the applet 200. The resources may be currently used by another process when the applet 200 is installed, but at execution, all the specified resources must be at the disposal of the applet 200. If the secure processor 180 has the necessary resources, the temporary variable resource is set to TRUE to designate that the required resources are present in the secure processor 180.

The security level supported by the secure processor 180, i.e., its security rating, must be verified at step 410 as at least as secure as the security level designated in the security meta-data 212. If the security level available in the secure processor 180 is at least as secure as the security level specified in the security meta-data 212, the applet 200 can be installed on the secure processor 180. If the applet 200 can be installed on the secure processor 180, the temporary variable security is set to TRUE to designate that the required security level is present on the secure processor 180.

Next the process 300 advances to step 310 in FIG. 3, where it is determined whether the applet can be installed. If the temporary variable security and the temporary variable resource are TRUE, the applet 200 can be installed. The meta-data portion 202 of the applet 200 is stored in the secure processor 180 and the process 300 advances to step 318. If either the temporary variable security or the temporary variable resource are FALSE, then the applet cannot be installed and the process 300 advances to step 312.

The secure processor 180 determines if there are any known alternative applets to the applet 200 at step 312. The installation of the applet 200 failed either because the secure processor 180 did not possess the required resources or because the secure processor 180 did not support the requisite security protocol. The secure processor 180 begins its determination as to whether any alternative applets exist by having the customer computer 170 request a list of alternative applets from the applet server 110. The customer computer 170 transmits a request for a list of alternative applets. The request includes the unique unit identifier 182, the applet serial number for the applet that could not be installed, the security rating of the secure processor 180 and the resource capabilities of the secure processor 180. If the list of alternative applets returned to the customer computer 170 from the applet server 110 is empty, the process 300 exits. If the list of alternative applets is not empty, the process 300 advances to step 314.

The secure processor 180 instructs the customer computer 170 to present the customer with the list of alternative applets at step 314. The customer can elect to install one of the alternative applets or reject the alternatives at step 316. If the customer elects to accept one of the alternative applets, the process 300 starts again at step 302. If the customer rejects the alternative applets, the process 300 exits.

The secure processor 180 requests a decryption key from the applet server 110 at step 318. The decryption key request includes the unique identity 182 and the applet serial number. The decryption key allows the secure processor 180 to decrypt the encrypted executable portion 222 of the applet 200. The secure processor 180 waits for the decryption key at step 320. If secure processor 180 receives the decryption key from the applet server 110, the secure processor 180 can continue with the installation of the applet 200 by advancing to step 322. If the customer computer 170 does not receive the decryption key from the applet server 110, the applet 200 cannot be installed and the process 300 exits. The encrypted executable portion 222 of the applet 200 is verified at step 322.

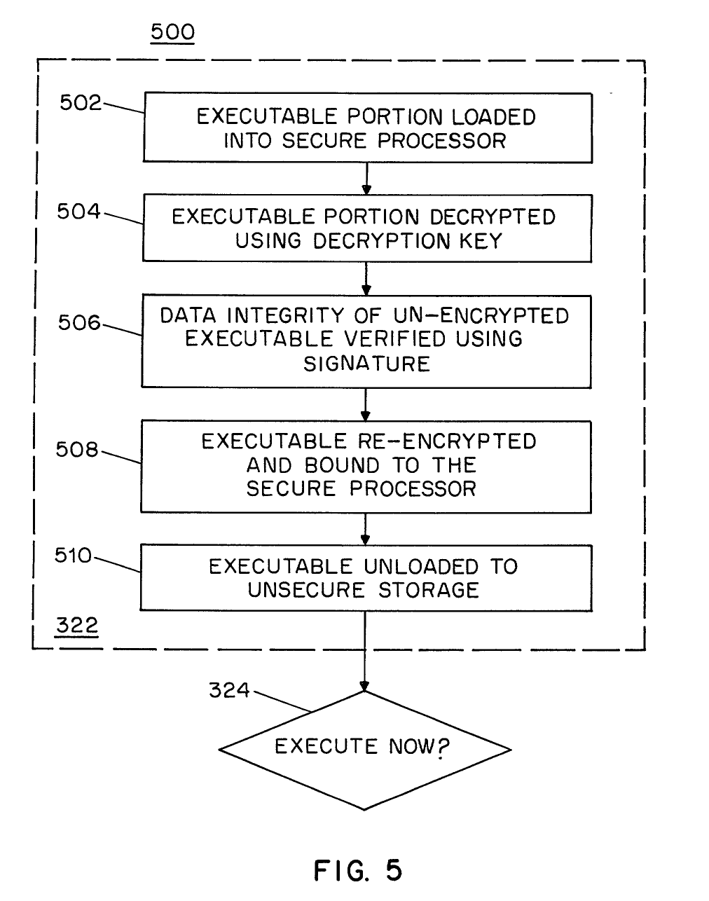

FIG. 5 shows in more detail the verification of the encrypted executable portion 222 of the applet 200 of step 322. To verify the encrypted executable portion 222, it must first be moved to the secure processor 180 from the data storage unit 174 at step 502. The encrypted executable 222 is decrypted into an unencrypted executable using the decryption key at step 504.

The data integrity of the unencrypted executable is verified at step 506. The secure processor 180 verifies the data integrity of the unencrypted executable by prepending the applet serial number to the unencrypted executable and verifying the executable signature portion 224 using a public key verification algorithm. In a certain embodiment, the Rivest, Shamir and Adleman algorithm is used. Before the applet server 110 downloads the applet, the executable signature portion 224 is created based on the data contained in the unencrypted executable with the applet serial number prepended onto the unencrypted executable. After the executable signature portion 224 is created, the applet serial number is stripped from the unencrypted executable, and the unencrypted executable is encrypted creating the encrypted executable 222. If any information in the encrypted executable 222, the unencrypted executable, or the applet serial number is altered between the time the unencrypted executable signature 216 was created and the time when the verification takes place on the secure processor 180, the verification process with fail. If the verification process fails, the process 300 exits. If the verification process detects no change in the unencrypted executable, the applet 200 can be installed.

The unencrypted executable is encrypted and bound to the secure processor 180 at step 508. The unencrypted executable is re-encrypted, and a local decryption key is created. The local decryption key is created by the secure processor 180, and is unique to the secure processor 180. The re-encrypted executable can only be decrypted by the local decryption key, which is stored in the secure processor 180, thus binding the encrypted executable to the secure processor 180. The re-encrypted executable is then unloaded to the data storage unit 174 at step 510, which completes step 322. The process 300 then advances to step 324 of FIG. 3.

At step 324, it is determined if execution is desired at this time. If execution is desired at this time, the process 300 proceeds to step 326. If execution is not desired at this time, the process 300 exits.

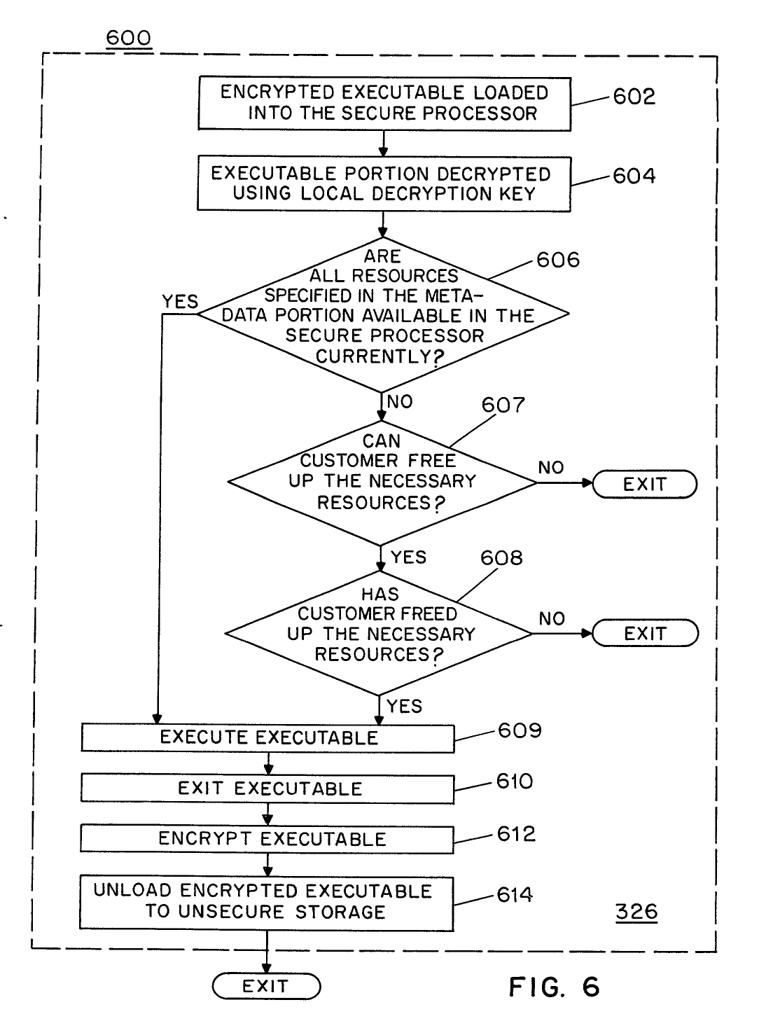

FIG. 6 shows in more detail the execution of the applet 200 at step 326. The execution process 600 can be activated on its own as well as part of the installation process. The encrypted executable is moved to the secure processor 180 from the data storage unit 174 at step 602. The encrypted executable 222 is decrypted in the secure processor 180 at step 604, using the local decryption key stored in the secure processor 180.

In order to execute the unencrypted executable, the resources specified in the meta-data portion 202 of the applet 200 must be available. The availability of the resources specified in the meta-data portion 202 of the applet 200 is verified at step 606. The secure processor 180 reads the required resources from the resource meta-data 214 of the meta-data portion 202 of the applet 200 which is stored in the secure processor 180. If the required resources of the secure processor 180 are free, the process advances to step 609. If the required resources of the secure processor 180 are not free, the process advances to step 607.

The secure processor 180 directs the customer computer 170 to display a message to the customer identifying the required resources that are not free and affords the customer the opportunity to free up the necessary resources at step 607. The unencrypted executable will only execute if all the resources it may need are available for its use. If the customer frees the required resources in step 608, the process 300 advances to step 609. If the customer cannot or does not free the required resources because another process is using the resources, or for any other reason, the process 300 exits. In an alternate embodiment, the secure processor 180 programmatically waits until the required resources are available. In another alternate embodiment, the secure processor 180 presents the customer with the option of delaying the execution of the applet until the required resources are free or not executing the applet at all. In yet another alternate embodiment, the resources are programmatically freed based on pre-established preferences or priorities.

In an alternative embodiment, if the customer can free the required resources, the process 300 returns to 606 instead of advancing to 608.

The secure processor 180 verifies that the required resources have been freed by the customer at step 608. If the customer has freed up the required resources, the process 600 advances to step 609. If the customer has not freed up the required resources, the process 300 exits. The unencrypted executable is executed by the secure processor 180 at step 609. The unencrypted executable performs whatever actions are required of it and exits at step 610. After the execution of the unencrypted executable ends, the unencrypted executable must be re-encrypted. The unencrypted executable is encrypted at step 612 and moved to the data storage unit 174, and the decryption key is stored in the secure processor 180, which completes step 324 and in turn process 300. This step is performed to re-encrypt any user or application data which is associated with the executable.

In an alternate embodiment, the steps 612 and 614 can be skipped if no changes were programmatically made by the secure processor 180 to the executable portion of the applet.

In an alternate embodiment, the steps 602 and 604 can be skipped during the installation process to allow for immediate execution of the executable after verification of the executable.

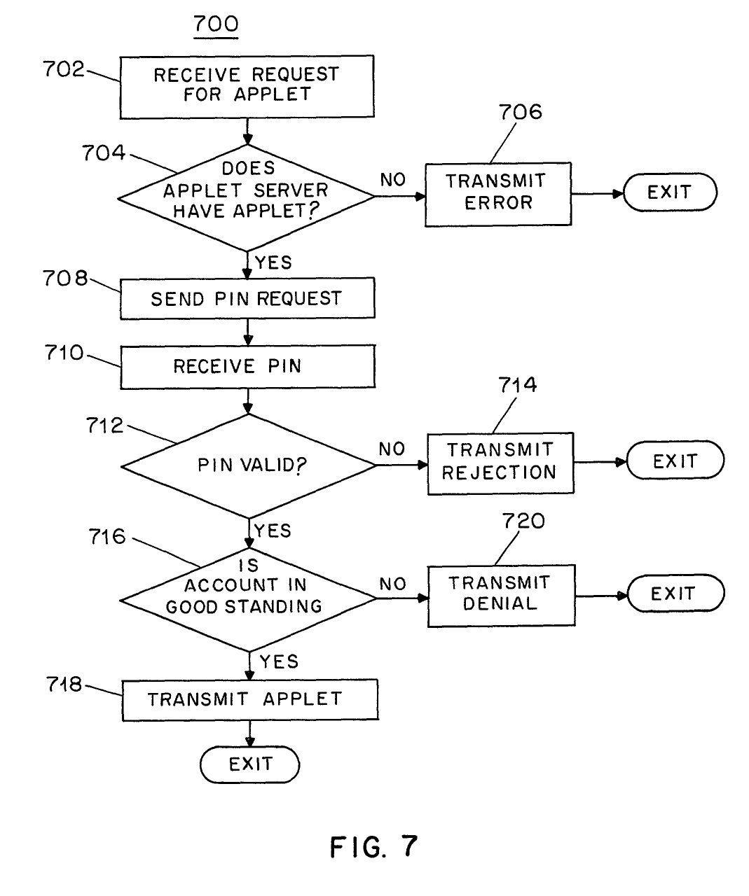

FIG. 7 illustrates a process 700 for responding to a request for an applet by the applet server 110. The applet server 110 receives a request for an applet at step 702. The request for the applet includes the unique unit identifier 182 and an applet serial number. At step 704 the applet server 110 searches the database 118 for the applet having the applet serial number specified in the request received at step 702. If the applet server 110 has the applet specified in the request received at step 702, the applet server 110 sends an authentication request to the customer computer 170 at step 708. If the applet server 110 does not have the applet specified in the request, the applet server 110 transmits an error message to the customer computer 170 at step 706 and exits process 700.

In an alternate embodiment, steps 708, 710, 712, 714, 716 are omitted and the process 700 goes directly from step 704 to step 716 if the applet server has the applet.

The applet server 110 receives the authentication code from the customer computer 170 at step 710. The applet server 110 validates the authentication code at step 712. The applet server 110 stores the authentication codes for each and every unique identity 182 registered in the database 118 of the applet server 110 when the secure processor 180 is initially registered. If the authentication code received by the applet server 110 at step 710 matches the authentication code for the unique identity 182 stored in the database 118, the process 700 advances to step 716. If the two codes do not match, the applet server 110 transmits a rejection to the customer computer 170 at step 714 and exits the process 700.

The applet server 110 verifies that the customer's account is in good standing at step 716. If the customer's account is not delinquent, the applet server 110 transmits the requested applet at step 718 and exits the process 700. If the customer's account is delinquent, the applet server transmits a denial to the customer computer 170 at step 720 and exits process 700. A customer's account may be considered delinquent if the customer's bill is not paid in a timely fashion, or for other business purposes such as being part of a group which is allowed to have permission to execute the applet.

In an alternative embodiment, the customer may have a deposit account on the applet server 110. If the deposit account has more money in it than a license for the requested applet costs, the account is not delinquent. In another alternative embodiment, the customer may have a credit card number on file at the applet server 110. If the credit card number can be charged for the amount it costs for a license for the requested applet, the account is not delinquent.

In an alternate embodiment, the customer may have a debit account on the secure processor 180. If the debit account has more money than the cost of the license for the requested applet, the local debit account may be used for the financial transaction associated with the applet installation charge.

In another alternative embodiment, the user may have a credit account on the secure processor 180. If this credit account can be used to create a real time credit transaction, the installation may proceed.

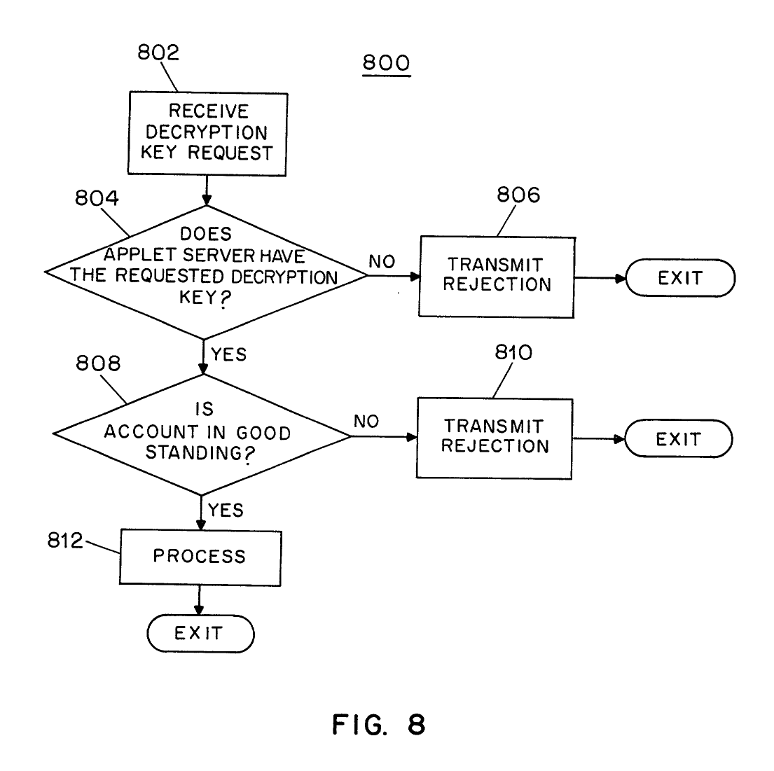

FIG. 8 illustrates a process 800 for responding to a request for a decryption key by the applet server 110. The applet server 110 receives a request for a decryption key for an applet at step 802. The request for the decryption key includes the unique unit identifier 182 and an applet serial number. At the step 804 the applet server 110 searches the database 118 for the decryption key for the applet identified in the request received at step 802. If the applet server 110 has the decryption key for the applet specified in the request received at step 802, the process 800 advances to step 808. If the applet server 110 does not have the correct decryption key, the applet server 110 transmits an error message to the customer computer 170 at step 806 and exits process 800.

The applet server 110 verifies that the customer's account is in good standing at step 808. If the customer's account is not delinquent, the applet server 110 transmits the requested decryption key at step 812 and exits the process 800. If the customer's account is delinquent, the applet server transmits a denial to the customer computer 170 at step 810 and exits process 800. A customer's account is delinquent if the customer's bill is not paid in a timely fashion.

In an alternative embodiment, the customer may have a deposit account on the applet server 110. If the deposit account has more money in it than a license for the requested applet costs, the account is not delinquent. In another alternative embodiment, the customer may have a credit card number on file at the applet server 110. If the credit card number can be charged for the amount it costs for a license for the requested applet, the account is not delinquent.

In an alternate embodiment, the customer may have a debit account on the secure processor 180. If the debit account has more money than the cost of the license for the requested applet, the local debit account may be used for the financial transaction associated with the applet installation charge.

In another alternative embodiment, the user may have a credit account on the secure processor 180. If this credit account can be used to create a real time credit transaction, the installation may proceed.

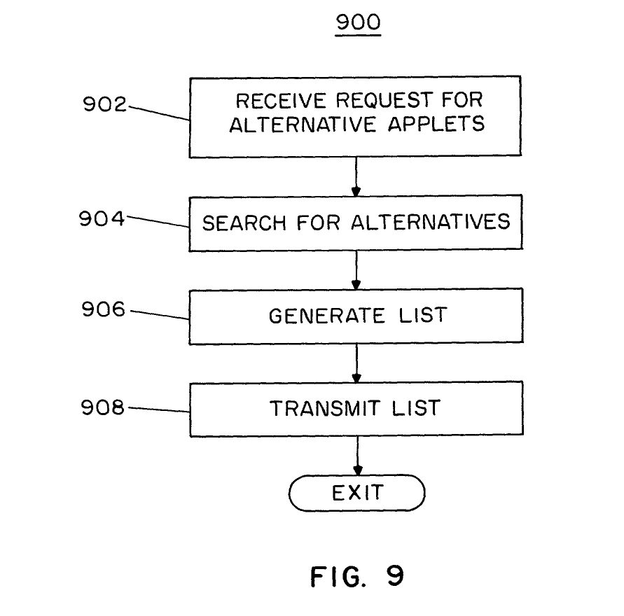

FIG. 9 illustrates a process 900 for responding to a request for alternative applets by the applet server 110. The applet server 110 receives a request for a list of alternative applets at step 902. The request for the list of alternative applets includes the unique unit identifier 182, an applet serial number, the security rating of the secure processor 180 and the resource capabilities of the secure processor 180.

The applet server 110 searches for known alternative applets to the applet 200 at step 904. The installation of the applet 200 failed either because the secure processor 180 did not possess the required resources or because the secure processor 180 did not support the requisite security protection. The applet server 110 analyzes the security rating of the secure processor 180 and the resource capabilities of the secure processor 180 to determine the reason behind the failed installation. The applet server 110 searches its database 118 for equivalent applets which require less resources, less stringent security measures, or both depending on the reason behind the failed installation.

The applet server 110 generates a list of alternative applets at step 906. The applet server takes the result from the database query executed at step 904 and generates a list of alternative applets from that data. The applet server 110 transmits the list of alternative applets to the customer computer 170 at step 908 whether or not the list is empty. After the list is transmitted the process 900 exits.

In an alternate embodiment, the level of security can be linked to the cost of the applet. In other words, the customer may have to pay a higher fee to receive the applet in the secure processor 180 if it has a lower security level than is typically required by the applet. Thus, the customer pays a premium for using the applet at the lower security level.

In an alternate embodiment, the cost of the applet 200 can be linked to the level of security provided by the applet. The customer may have to pay a higher fee for a more secure service because the higher security service provides a greater level of service integrity.

In another alternative embodiment, equivalent security levels can be assigned by the amount of auditing performed. The greater the amount of auditing in the system, the greater the security level required. Independent third party corporations, which specialize in validation of security hardware and security software, may independently assign security levels to the secure processor and applet. By having respected and industry trusted third parties validate the environment and associated services, it is possible to provide a greater level of certification and additionally provide for insurance or other underwriting to distribute the liability of the service.

With the ability of applet publishers to specify resources and security requirements of their services, hardware providers specifying resource and security levels offered by their secure processors, and users specifying minimum security requirements for their preferences, it is possible to create a customized secure execution capability on a customer computer which satisfies all the requirements for a diverse set of multi-party transaction types.

What is claimed is:

1. A method for securely installing an applet on a computer system having a data storage and a secure processor, comprising:
receiving an applet in a data storage;
determining from at least a portion of the applet whether the applet is capable of being executed by a secure processor; and
installing the applet on the secure processor if the secure processor is capable of executing the applet.

2. The method according to claim 1, wherein the applet is stored in a non-secure storage.

3. The method according to claim 2, wherein the applet further comprises:
a meta-data portion; and
an executable portion.

4. The method according to claim 3, wherein the applet further comprises a certificate portion.

5. The method according to claim 3, wherein the meta-data portion further comprises:
a security meta-data portion;
a resource meta-data portion which designates any resources required by the applet for execution; and
a meta-data signature portion.

6. The method according to claim 5, wherein the resource meta-data portion is adapted to designate resources comprising at least one of:
a biometric sensor;
a secure output;
a keyboard;
a personal identification number entry device;
a global positioning system input;
a magnetic stripe card reader;
a secure storage area;
a performance metrics,
an algorithm implementing specific cryptographic algorithms; and
at least one smart card slot.

7. The method according to claim 5, wherein the step of determining whether the applet is capable of being executed by the secure processor further comprises loading the meta-data portion of the applet into a secure storage area in the secure processor.

8. The method according to claim 7, wherein the step of determining whether the applet is capable of being executed by the secure processor further comprises cryptographically verifying the security meta-data portion and the resource meta-data portion of the meta-data portion of the applet against the signature portion of the meta-data portion of the applet.

9. The method according to claim 7, wherein the step of determining whether the applet is capable of being executed by the secure processor further comprises verifying that a secure processor security requirement of the security meta-data portion of the applet is met or exceeded by a secure processor security rating of the secure processor.

10. The method according to claim 9, wherein the step of determining whether the applet is capable of being executed by the secure processor further comprises:
determining that the secure processor security requirement of the security meta-data portion of the applet is not met or exceeded by a secure processor security rating of the secure processor; and
suggesting the use of a second applet that may have a second secure processor security requirement that is met or exceeded by the secure processor security rating of the secure processor.

11. The method according to claim 10, wherein the step of determining whether the applet is capable of being executed by the secure processor further comprises charging a premium for the use of the second applet.

12. The method according to claim 7, wherein the step of determining whether the applet is capable of being executed by the secure processor further comprises verifying that the secure processor is capable of supplying resources designated in the resource meta-data portion of the meta-data portion of the applet.

13. The method according to claim 12, wherein the step of determining whether the applet is capable of being executed by the secure processor further comprises:
determining that the secure processor is not capable of supplying at least one of the resources designated in the resource meta-data portion of the meta-data portion of the applet; and
suggesting the use of a second applet that may designate only resources that the secure processor is capable of supplying.

14. The method according to claim 3, wherein the executable portion further comprises:
an encrypted executable; and
an unencrypted executable signature.

15. The method according to claim 14, wherein the step of installing the applet on the secure processor further comprises storing the executable portion of the applet in the secure storage area.

16. The method according to claim 15, wherein the step of installing the applet on the secure processor further comprises:
requesting a decryption key for the encrypted executable portion of the applet;
receiving the decryption key; and
decrypting the encrypted executable portion into an unencrypted executable portion using the decryption key.

17. The method according to claim 16, wherein the step of installing the applet on the secure processor further comprises verifying the unencrypted executable portion against the unencrypted executable signature.

18. The method according to claim 16, wherein the step of installing the applet on the secure processor further comprises verifying the unencrypted executable portion prepended with an applet serial number against the unencrypted executable signature.

19. The method according to claim 17, wherein the step of installing the applet on the secure processor further comprises binding the unencrypted executable portion to the secure processor.

20. The method according to claim 17, wherein the step of installing the applet on the secure processor further comprises:
encrypting the unencrypted executable portion to an encrypted executable;
storing the encrypted executable in the non-secure storage; and
storing the encrypted executable's decryption key in the secure storage area.

21. The method according to claim 1, wherein the computer system further comprises a non-secure processor.

22. A method for securely installing an applet on a computer system having a data storage and a secure processor, comprises:
receiving an applet in a non-secure data storage, said applet comprises:
a meta-data portion, said meta-data portion comprises:
a security meta-data portion;
a resource meta-data portion which designates any resources required by the applet for execution; and
a meta-data signature portion; and
an executable portion;
determining whether the applet is capable of being executed by a secure processor based at least in part on the security meta-data portion and the resource meta-data portion of the applet, comprises:
verifying that a secure processor security requirement of the security meta-data portion of the applet is met or exceeded by a secure processor security rating of the secure processor; and
verifying that the secure processor is capable of supplying the resources designated in the resource meta-data portion of the meta-data portion of the applet; and
installing the applet on the secure processor if the secure processor is capable of executing the applet.

23. The method according to claim 22, wherein the step of determining whether the applet is capable of being executed by the secure processor further comprises verifying the security meta-data portion and the resource meta-data portion of the meta-data portion of the applet against the signature portion of the meta-data portion of the applet.

24. The method according to claim 23, wherein the step of determining whether the applet is capable of being executed by the secure processor further comprises:
determining that the secure processor security requirement of the security meta-data portion of the applet is not met or exceeded by a secure processor security rating of the secure processor; and
suggesting the use of a second applet that may have a second secure processor security requirement that is met or exceeded by the secure processor security rating of the secure processor.

25. The method according to claim 24, wherein the step of determining whether the applet is capable of being executed by the secure processor further comprises charging a premium for the use of the second applet.

26. The method according to claim 22, wherein the step of installing the applet on the secure processor further comprises storing the executable portion of the applet in the secure storage area.

27. The method according to claim 26, wherein the step of installing the applet on the secure processor further comprises:
requesting a decryption key for the encrypted executable portion of the applet;
receiving the decryption key; and
decrypting the encrypted executable portion into an unencrypted executable portion using the decryption key.

28. The method according to claim 26, wherein the step of installing the applet on the secure processor further comprises:
decrypting the encrypted executable portion into an unencrypted executable portion using a decryption key; and
binding the unencrypted executable portion to the secure processor.

29. The method according to claim 28, wherein the step of installing the applet on the secure processor further comprises:
encrypting the unencrypted executable portion to an encrypted executable;
storing the encrypted executable in the non-secure storage; and
storing the encrypted executable's decryption key in the secure storage area.

30. A method for providing a list of alternative applets for a first applet which could not be installed in a computer having at least one resource and having a secure processor which is associated with a security rating, comprising:
receiving a request from a secure processor for a list of alternative applets;
the request comprising:
an applet serial number which identifies a first applet;
an identifier which identifies the secure processor;
a first indicator which identifies a security rating of the secure processor; and
a second indicator which identifies the at least one resource of the computer;
creating the list of alternative applets from the plurality of applets based at least in part on the first indicator and the second indicator; and
transmitting the list of alternative applets to the computer.

31. The method according to claim 30, further comprises:
installing an alternative applet from the list of alternative applets; and
charging a premium for installing the alternative applet.

32. The method according to claim 30, wherein the identifier identifies the secure processor uniquely.

33. A secure applet execution system, comprising:
a data storage element storing an applet received by the secure applet execution system; and
a secure processor determining from at least a portion of the applet whether the applet is capable of being executed by the secure processor, and installing the applet on the secure processor if the secure processor is capable of executing the applet.

34. The secure applet execution system according to claim 33, wherein the applet further comprises:
a meta-data portion; and
an executable portion.

35. The secure applet execution system according to claim 34, wherein the applet further comprises a certificate portion.

36. The secure applet execution system according to claim 35, wherein the meta-data portion further comprises:
a security meta-data portion;
a resource meta-data portion which designates any resources required by the applet for execution; and
a meta-data signature portion.

37. A secure applet execution system, comprising:
a non-secure data storage element storing an applet received by the secure applet execution system;
said applet comprising:
a meta-data portion; and
an executable portion;
said meta-data portion, comprising:
a security meta-data portion;
a resource meta-data portion which designates any resources required by the applet for execution; and
a meta-data signature portion; and
a secure processor determining from at least a portion of the applet whether the applet is capable of being executed by the secure processor, and installing the applet on the secure processor if the secure processor is capable of executing the applet.

38. A secure applet configured to include a cryptographically secure executable, comprising:
a meta-data portion, said meta-data portion including:
a security meta-data portion;
a resource meta-data portion; and
a meta-data signature portion;
an executable portion, said encrypted executable portion including:
an encrypted executable portion; and
an unencrypted executable signature portion; and
a certificate portion.

39. The secure applet according to claim 38, wherein said security meta-data portion comprises information describing security requirements necessary for the decryption and execution of the encrypted executable portion.

40. The secure applet according to claim 38, wherein the resource meta-data portion comprises information describing resources necessary to execute the encrypted executable portion.

41. The secure applet according to claim 38, wherein the resource meta-data portion comprises an applet serial number.

42. The secure applet according to claim 41, wherein the unencrypted signature portion comprises information adapted to verify whether the encrypted executable portion, when decrypted and prepended by the applet serial number, has been modified in any way.

43. The secure applet according to claim 38, wherein the meta-data signature portion comprises information adapted to verify whether the security meta-data portion and the resource meta-data portion have been modified in any way.
